(19) United States
(12) Patent Application Publication
(10) Pub. No.: US 2017/0313161 A1
(43) Pub. Date: Nov. 2, 2017

(54) HEATING, VENTILATION AND/OR AIR-CONDITIONING DEVICE FOR A MOTOR VEHICLE

(71) Applicant: Valeo Systemes Thermiques, Le Mesnil Saint Denis (FR)

(72) Inventors: Julien Brault, Le Mesnil Saint Denis (FR); Stéphane Pernet, Le Mesnil Saint Denis (FR)

(73) Assignee: Valeo Systemes Thermiques, Le Mesnil Saint Denis (FR)

(21) Appl. No.: 15/531,136

(22) PCT Filed: Oct. 28, 2015
(86) PCT No.: PCT/EP2015/074935

§ 371 Date: May 26, 2017

(30) Foreign Application Priority Data
Nov. 28, 2014 (FR) 1461662

(51) Int. Cl. B60H 3/00; B60H 1/00

(52) U.S. Cl. CPC B60H 3/0092; B60H 1/00571; B60H 1/00028; B60H 2001/00135

(57) ABSTRACT

The invention relates to a heating, ventilation and/or air-conditioning device (1) for a motor vehicle, characterised in that it comprises at least one first air circulation channel (3), at least one second air circulation channel (4), and means (5, 6) for generating an air stream in the first air circulation channel (3) and/or in the second air circulation cannel (4), the device (1) also comprising means for the inflow of a cleaning product (13, 16) ending in the first air circulation channel (3) and/or in the second air circulation channel (4).

The present invention relates to a heating, ventilation and/or air-conditioning device for an automobile.

An automobile comprises a car interior into which air conventionally originating from a heating, ventilation and/or air-conditioning device is released.

The vehicle comprises in particular one or more defrosting nozzles located in proximity to the windshield, ventilators located at the level of the dashboard and intended to deliver air to the driver and passenger, and nozzles located at the level of the driver's and passenger's feet (floor nozzles).

The heating, ventilation and/or air-conditioning (HVAC) device may be supplied either with air from outside the vehicle (also called fresh air) or with recycled air, i.e. air coming from the car interior.

External air generally contains little moisture when it is cold, in comparison with recycled air, but may be relatively cold especially in winter conditions. Recycled air generally has a higher moisture content than that of external air and is at a temperature close to the temperature to be achieved, which is to say close to the setpoint temperature defined by the driver or the passenger, for example.

Depending on the operating conditions, it may therefore be especially beneficial to use external air for introduction into the car interior at the level of the defrosting nozzles located in proximity to the windshield, after said external air has been heated by way of the abovementioned device, for example. Since the moisture content of fresh air is relatively low, the risk of condensation forming on the windshield is therefore also low.

Conversely, it may be advantageous to use recycled air in order to expel same into the car interior at the level of the floor nozzles. In this way, even in winter conditions and when a large flow rate of air is required by the driver or the passenger, it is possible to heat this recycled air more rapidly to the setpoint temperature before said air is expelled into the car interior. The comfort for the users is considerably improved and the risk of condensation forming on the windshield is low because this recycled air is expelled at a distance from the windshield.

In order to make full use of such advantages, it is important to be able to separate the airflows (external air—recycled air), especially while said airflows are passing through the heating, ventilation and/or air-conditioning device.

A heating, ventilation and/or air-conditioning (HVAC) device conventionally comprises a single air circulation duct equipped with an impeller driven in rotation by an electric motor in order to blow air into the air circulation duct.

An evaporator is generally located downstream of the air circulation duct, said evaporator enabling heat exchange between the air circulating in the duct and the air outside the vehicle.

During operation, water condenses in the evaporator to form a suitable environment for the development of bacteria and malodors. Some of these bacteria and odors may then be carried with the airflow and contaminate the whole ventilation circuit as well as the car interior.

In order to remedy this drawback, it is known to clean the evaporator by injecting a cleaning product into the ventilation circuit. The injection zone for such a product may vary according to the applications.

In order to ensure that the two airflows are separated while the cleaning function is maintained, the invention provides a heating, ventilation and/or air-conditioning device for an automobile, characterized in that it comprises at least one first air circulation duct, at least one second air circulation duct, and means for generating an airflow in the first air circulation duct and/or in the second air circulation duct, the device further comprising cleaning-product inlet means, opening into the first air circulation duct and/or into the second air circulation duct.

A cleaning product may thus be injected into the first air circulation duct and/or into the second air circulation duct.

Preferably, at least one evaporator is located downstream of the first air circulation duct and/or downstream of the second air circulation duct, the cleaning-product inlet means being located upstream of the evaporator in the direction of circulation of the corresponding airflow.

Moreover, the cleaning-product inlet means are located downstream of the means for generating the corresponding airflow in the direction of circulation of said airflow.

The cleaning-product inlet means may comprise a cleaning-product inlet duct opening into the corresponding air circulation duct, and a connecting piece separated from said inlet duct by closure means.

When cleaning is necessary, it is thus sufficient to remove the closure means in order to be able to inject the cleaning product.

The closure means preferably comprise at least one wall able to be punctured.

The cleaning-product inlet duct may comprise a bent portion having a generally circular arc shape.

In this way, if the product is injected by way of a flexible tube, said tube can be introduced into the connecting piece and into the inlet duct while being guided by the bent portion.

According to one mode of embodiment, the device may comprise a first cleaning-product inlet duct opening into the first air circulation duct and a second cleaning-product inlet duct opening into the second air circulation duct, the first air circulation duct being formed at least partly by a first volute, the second air circulation duct being formed at least partly by a second volute, the first and second air circulation ducts being at least partly separated from each other by a partition wall.

In this case, the first cleaning-product inlet duct and the second cleaning-product inlet duct may be formed at least partly as a single piece with the partition wall.

In particular, the separating wall may form a means for separating said cleaning-product inlet ducts.

Moreover, the first cleaning-product inlet duct, the second cleaning-product inlet duct, the corresponding connecting pieces and/or the corresponding closure means may be formed at least partly as a single piece with the first volute and/or the second volute.

The number of components to be manufactured and assembled is thus reduced. The partition wall and the volutes may be made of plastic and be formed by injection molding, for example.

The invention also relates to an automobile comprising at least one device of the type described above.

The invention will be better understood and other details, features and advantages of the invention will become apparent on reading the following description which is given by way of non-limiting example and with reference to the appended drawings in which:

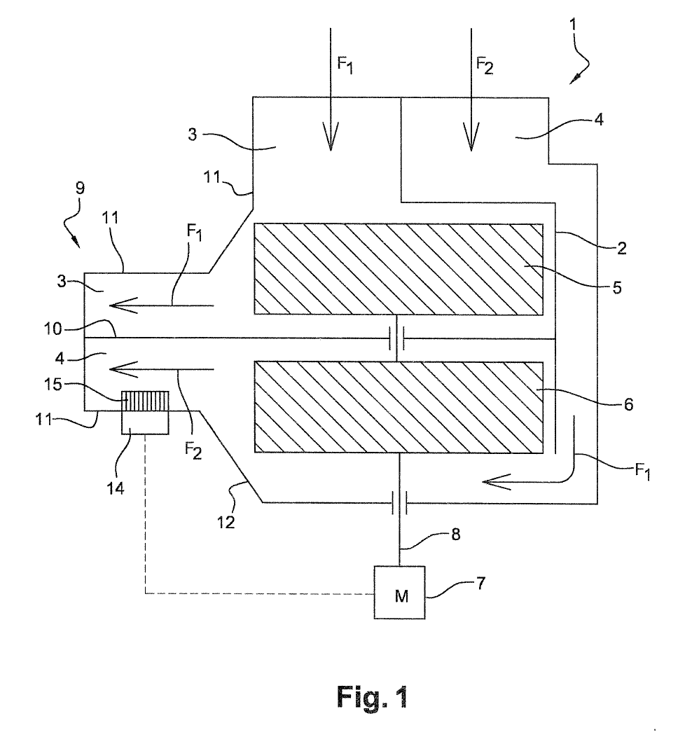

FIG. 1 is a schematic view in cross section of a device according to a mode of embodiment of the invention;

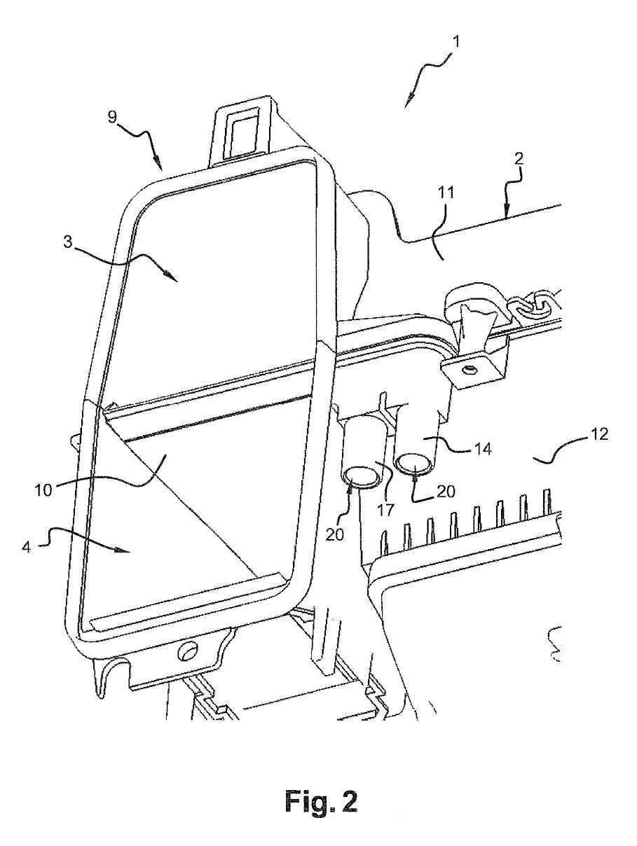

FIG. 2 is a perspective view of part of the device in FIG. 1;

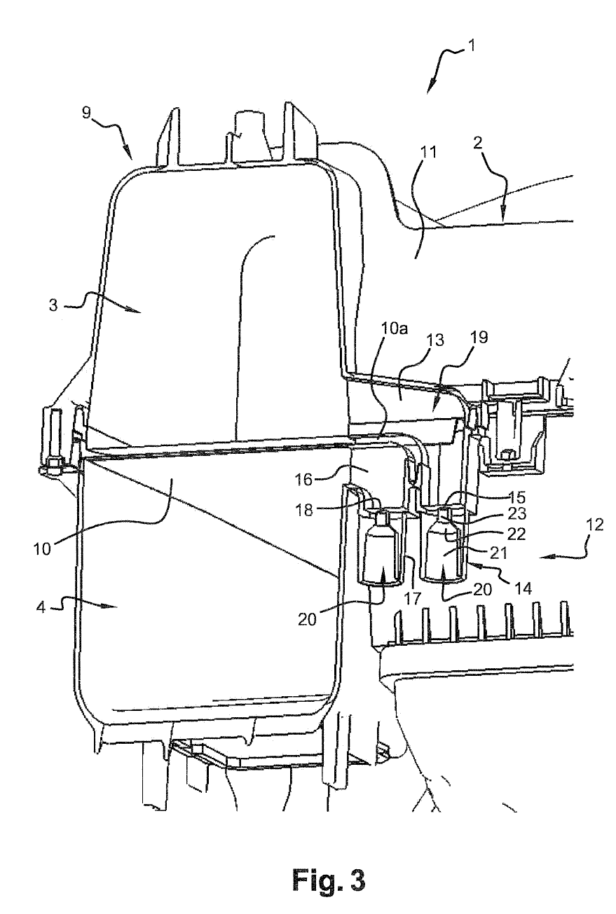

FIG. 3 is a perspective view in cross section of part of the device in FIG. 1; and

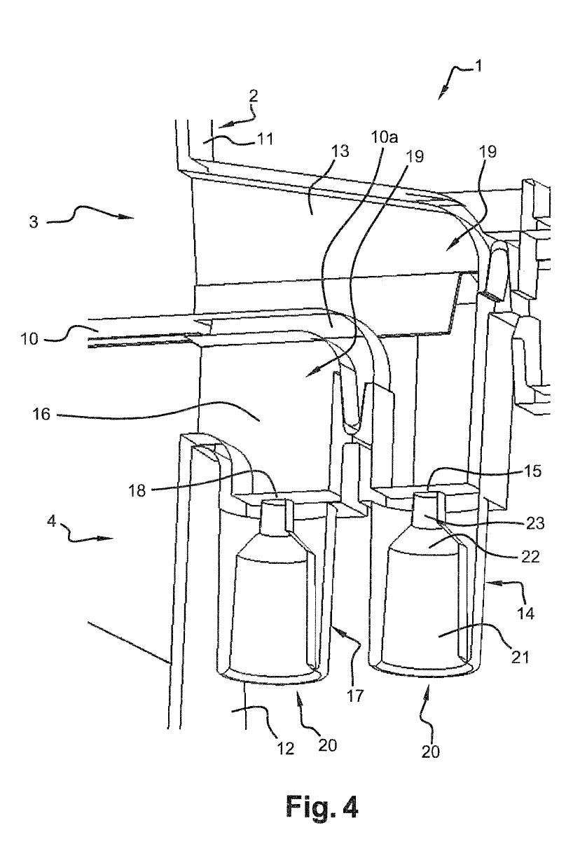

FIG. 4 is a detailed view illustrating more particularly the cleaning-product inlet means.

A heating, ventilation and/or air conditioning device 1 according to a first mode of embodiment is illustrated in FIG. 1 and FIG. 2. This device is intended to be fitted in an automobile and comprises a body 2 defining a first fluid circulation duct 3 and a second fluid circulation duct 4. The body comprises means able to blow air. These means comprise a first impeller 5 mounted in the first fluid circulation duct 3 and a second impeller 6 mounted in the second fluid circulation duct 4, these two impellers 5, 6 being driven by the same electric motor 7.

More particularly, according to the mode of embodiment illustrated in FIG. 1, the motor 7 comprises a transmission shaft 8 projecting from a single side of the motor 7, the first impeller 5 and the second impeller 6 being fixed to said transmission shaft 8. As a variant, the motor 7 may comprise a transmission shaft projecting on both sides of the motor 7, respectively at the level of a first part coupled to the first impeller 5 and a second part coupled to the second impeller 6.

The body 2 comprises a downstream zone 9, i.e. located downstream of the impellers 5 and 6 in the direction of circulation of the corresponding airflows F1, F2. The first and second air circulation ducts 3, 4 are separated, at least in the downstream zone 9 of the body 2, by a separating wall 10 formed as a single piece from a plastic material, for example by injection.

The first air circulation duct 3 is preferably defined by a first volute 11 formed as a single piece from a plastic material, for example by injection, and by the separating wall 10.

The second air circulation duct 4 is preferably defined by a second volute 12 formed as a single piece from a plastic material, for example by injection, and by the separating wall 10.

The body 2 is thus formed by assembly of the volutes 11, 12 and of the separating wall 10.

During operation, the motor 7 is started up in such a way as to drive the impellers 5, 6 in rotation. A first airflow F1 can then circulate through the first duct 3 before being led out into a first zone of the automobile interior, for example at the level of the defrosting nozzles located in proximity to the vehicle windshield.

A second airflow F2 may circulate through the second duct 4 before being led out into a second zone of the automobile interior, for example at the level of the floor nozzles disposed opposite the driver's and passenger's feet.

The first airflow F1 and/or the second airflow F2 may be flows of air from outside the vehicle or of recycled air originating from the car interior, or else be a mixture of external air and recycled air.

According to the invention, the device 1 comprises first and second cleaning-product inlet means, opening respectively into the ducts 3, 4 in the downstream part 9 of the body 5 and upstream of at least one evaporator which is not depicted.

The first inlet means comprise a first cleaning-product inlet duct 13 opening into the first air circulation duct 3 and a first connecting piece 14 separated from said first inlet duct 13 by closure means, such as for example a thin wall 15 able to be punctured, for example by piercing.

The second inlet means likewise comprise a second cleaning-product inlet duct 16 opening into the second air circulation duct 4 and a second connecting piece 17 separated from said second inlet duct by closure means, such as for example a thin wall 18 able to be punctured, for example by piercing.

Each cleaning-product inlet duct 13, 16 comprises a bent portion 19 having a generally circular arc shape.

Each connecting piece 14, 17 comprises a recess 20 including a first frustoconical part 21 opening opposite the closure wall and extended in the direction of the corresponding closure wall by a second frustoconical part 22 and then by a cylindrical part 23 having a smaller cross section and having a bottom which is closed off by said closure wall 15, 18 when said closure wall is not punctured.

More particularly, the partition wall 10 forms part of the first and second cleaning-product inlet ducts 13, 16.

In particular, the separating wall 10 forms a means 10a for separating the first and second cleaning-product inlet ducts 13, 16.

Furthermore, the volute 12 forms part of the first and second cleaning-product inlet ducts 13, 16, said volute 12 further forming the first and second connecting pieces 14, 17 as well as the corresponding closure walls 15, 18. Finally, the volute 11 forms part of the first cleaning-product inlet duct 13. The number of pieces to be produced and assembled is thus limited.

During operation, water condenses in the evaporator to form a suitable environment for the development of bacteria and malodors. Some of these bacteria and odors may then be carried with the airflow F1, F2 and contaminate the whole ventilation circuit as well as the car interior.

The following procedure may adopted in order to remedy this drawback.

The wall 15, 18 is first of all punctured by piercing, for example. The cleaning product is then injected into the ducts 3, 4, this product being carried by the airflows F1, F2 into the evaporators located downstream. For this purpose, a flexible tube may be introduced into the recesses 20 and into the ducts 13, 16, the curved portions 19 being able to serve to guide and to bend the flexible tube. As a variant, it is also possible to connect what is known as a “male” part of a pipe in each recess, this recess then forming what is known as a “female” part, and the cleaning product originating from the pipe passes through the punctured wall and the corresponding inlet part before being led out into the corresponding duct 3, 4.

1. A heating, ventilation and/or air-conditioning device for an automobile, comprising:
at least one first air circulation duct;
at least one second air circulation duct;
means for generating an airflow in the first air circulation duct and in the second air circulation duct; and
cleaning-product inlet means, opening into the first air circulation duct and/or into the second air circulation duct.

2. The device as claimed in claim 1, in which at least one evaporator is located downstream of the first air circulation duct and/or downstream of the second air circulation duct, the cleaning-product inlet means being located upstream of the evaporator in the direction of circulation of the corresponding airflow.

3. The device as claimed in claim 1, wherein the cleaning-product inlet means are located downstream of the means for generating the corresponding airflow in the direction of circulation of said airflow.

4. The device as claimed in claim 1, wherein the cleaning-product inlet means comprise a cleaning-product inlet duct opening into the corresponding air circulation duct, and a connecting piece separated from said inlet duct by closure means.

5. The device as claimed in claim 4, wherein the closure means comprise at least one wall able to be punctured.

6. The device as claimed in claim 4, wherein the cleaning-product inlet duct comprises a bent portion having a circular arc shape.

7. The device as claimed in claim 4, further comprising:
a first cleaning-product inlet duct opening into the first air circulation duct; and
a second cleaning-product inlet duct opening into the second air circulation duct,
the first air circulation duct being formed at least partly by a first volute, the second air circulation duct being formed at least partly by a second volute, the first and second air circulation ducts being at least partly separated from each other by a partition wall.

8. The device as claimed in claim 7, wherein the first cleaning-product inlet duct and the second cleaning-product inlet duct are formed at least partly as a single piece with the partition wall.

9. The device as claimed in claim 8, wherein the first cleaning-product inlet duct, the second cleaning-product inlet duct, the corresponding connecting pieces and the corresponding closure means are formed at least partly as a single piece with the first volute and/or the second volute.

10. An automobile comprising at least one device as claimed in claim 1.
